(19) United States
(12) Patent Application Publication
(10) Pub. No.: US 2013/0332586 A1
(43) Pub. Date: Dec. 12, 2013

(54) PROVIDING IPV6 CONNECTIVITY THROUGH SHARED EXTERNAL INTERFACES ON ELECTRONIC DEVICES

(71) Applicants: Cahya A. Masputra, San Jose, CA (US); Delziel J. Fernandes, Cupertino, CA (US)

(72) Inventors: Cahya A. Masputra, San Jose, CA (US); Delziel J. Fernandes, Cupertino, CA (US)

(73) Assignee: APPLE INC., Cupertino, CA (US)

(21) Appl. No.: 13/528,629

(22) Filed: Jun. 20, 2012

Related U.S. Application Data
(60) Provisional application No. 61/657,384, filed on Jun. 8, 2012.

(51) Int. Cl. G06F 15/177

(52) U.S. Cl. 709/220

(57) ABSTRACT

The disclosed embodiments provide a system that shares an Internet connection. During operation, the system provides, on an electronic device, an external interface with the Internet connection and a set of internal interfaces sharing the external interface. Upon detecting a support of Internet Protocol version 6 (IPv6) by the external interface, the system configures the electronic device to provide IPv6 connectivity to the internal interfaces. First, the system provides an IPv6 router to client devices connected to the internal interfaces. Next, the system uses the IPv6 router and an IPv6 prefix from the Internet connection to perform prefix proxying with the client devices.

### RELATED APPLICATION

This application claims priority to U.S. Provisional Application No. 61/657,384, Attorney Docket Number APL-P12710USP1, entitled “Providing IPV6 Connectivity Through Shared Network Interfaces on Electronic Devices,” by inventors Cahya A. Masputra and Delziel J. Fernandes, filed 8 Jun. 2012, the contents of which are incorporated herein by reference.

The subject matter of this application is related to the subject matter in a co-pending non-provisional application by inventor Cahya A. Masputra, entitled “System and Method for Managing Routers and Communication Interfaces on a Computing Device,” having Ser. No. 13/007,446, and filing date 14 Jan. 2011 (Attorney Docket No. 4860.P10428).

### BACKGROUND

1. Field

The disclosed embodiments relate to electronic devices that provide network connections. More specifically, the disclosed embodiments relate to techniques for providing Internet Protocol version 6 (IPv6) connectivity through shared external interfaces on electronic devices.

2. Related Art

Websites, content providers, and Internet Service Providers (ISPs) are currently transitioning from Internet Protocol version 4 (IPv4) to Internet Protocol version 6 (IPv6) for routing packets between network nodes. Such a transition may expand the Internet Protocol (IP) address space from about 4.3 billion addresses to 3.4×10³⁸ addresses and resolve issues associated with IPv4 address exhaustion.

However, advantages associated with IPv6 may not be fully realized until most Internet hosts and network infrastructure connecting the Internet hosts have deployed IPv6. In addition, deployment of IPv6 has been slow, and transmission of network traffic between IPv4 and IPv6 networks typically requires translator gateways and/or other transition mechanisms for allowing IPv6 hosts to reach IPv4 services and/or the IPv6 Internet over IPv4 infrastructure. Consequently, Internet connectivity may be facilitated by increased adoption of IPv6 by hosts, routers, and/or other network nodes on the Internet.

### SUMMARY

The disclosed embodiments provide a system that shares an Internet connection. During operation, the system provides, on an electronic device, an external interface with the Internet connection and a set of internal interfaces sharing the external interface. Upon detecting a support of Internet Protocol version 6 (IPv6) by the external interface, the system configures the electronic device to provide IPv6 connectivity to the internal interfaces. First, the system provides an IPv6 router to client devices connected to the internal interfaces. Next, the system uses the IPv6 router and an IPv6 prefix from the Internet connection to perform prefix proxying with the client devices.

In some embodiments, upon detecting the support of IPv6 by the external interface, the system also configures the electronic device to provide IPv6 Domain Name System (DNS) information to the client devices.

In some embodiments, the IPv6 DNS information is provided to the client devices using at least one of a stateless Dynamic Host Configuration Protocol (DHCP) server and a router advertisement from the electronic device to the client devices.

In some embodiments, detecting the support of IPv6 by the external interface includes detecting a link-local IPv6 address and the IPv6 prefix for the external interface.

In some embodiments, the IPv6 prefix information includes at least one of the IPv6 prefix, one or more flags, and a prefix lifetime.

In some embodiments, detecting the support of IPv6 by the external interface further includes detecting a configurability of IPv6 addresses by the client devices using IPv6 prefix information for the IPv6 prefix. For example, the IPv6 addresses may configurable by the client devices if the IPv6 prefix is 64-bits long, an “autoconfigure” flag in the prefix information is set, and/or the prefix lifetime is not expired.

In some embodiments, providing the IPv6 router to the client devices includes:
(i) using a router advertisement to provide the IPv6 prefix information to the client devices;
(ii) tracking IPv6 addresses generated using the IPv6 prefix by the client devices; and
(iii) using the tracked IPv6 addresses to route packets between the external interface and the client devices.

In some embodiments, using the IPv6 router and the IPv6 prefix from the Internet connection to perform prefix proxying with the client devices includes:
(i) transmitting a router advertisement for the IPv6 router to the client devices;
(ii) performing neighbor discovery between the client devices using the IPv6 prefix; and
(iii) using information from the neighbor discovery to build a routing table for the IPv6 router.

In some embodiments, the routing table includes an unscoped routing entry for the external interface and a set of scoped routing entries for the internal interfaces.

In some embodiments, the internal interfaces include at least one of a Universal Serial Bus (USB) interface, a Bluetooth interface, and a WiFi interface.

### BRIEF DESCRIPTION OF THE FIGURES

FIG. 1 shows a schematic of a system in accordance with the disclosed embodiments.

FIG. 2 shows a system for sharing an Internet connection in accordance with the disclosed embodiments.

FIG. 3 shows the configuring of an electronic device to provide an IPv6 router to a set of client devices in accordance with the disclosed embodiments.

FIG. 4 shows the performing of prefix proxying by an electronic device with a set of client devices in accordance with the disclosed embodiments.

FIG. 5 shows a flowchart illustrating the process of sharing an Internet connection in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

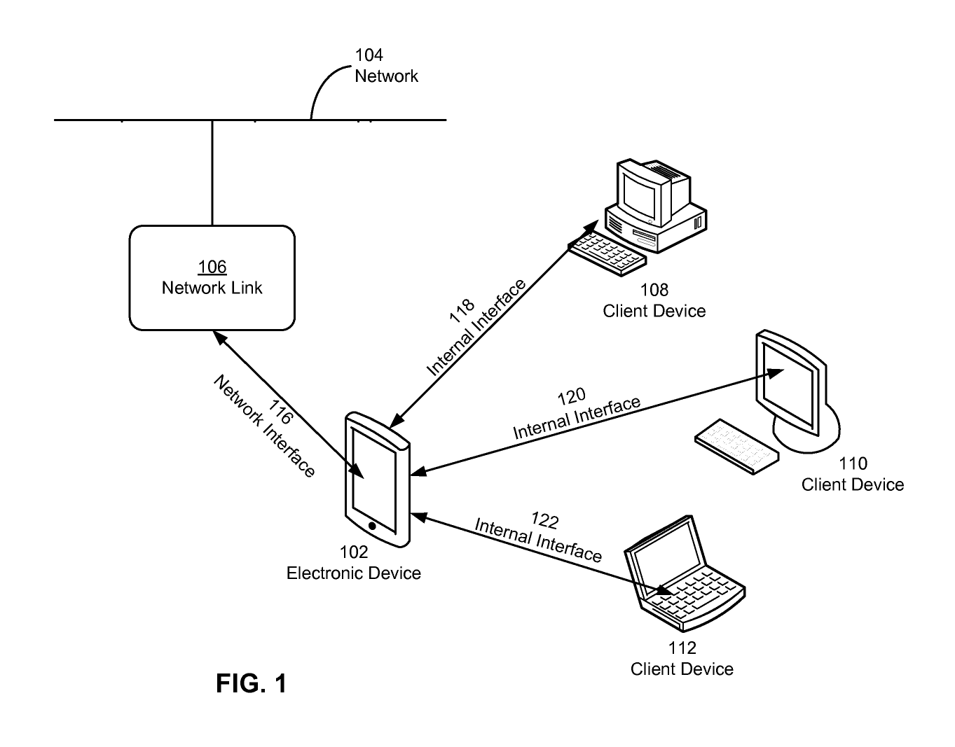

The disclosed embodiments provide a method and system for sharing an Internet connection. As shown in FIG. 1, an electronic device 102 may be connected to a network 104 through an external interface 116 with a network link 106 of network 106. Electronic device 102 may also share access to network 104 with a set of client devices 108-112 through a set of internal interfaces 118-122 with client devices 108-112.

More specifically, electronic device 102 may be a mobile phone, tablet computer, personal computer, and/or other device with functionality to connect to a cell tower providing network link 106 on a cellular network 104. For example, electronic device 102 may use a 3^{rd} Generation Partnership Project (3GPP) standard to communicate with the cell tower and/or access the Internet through the cell tower.

Electronic device 102 may then share the Internet connection with client devices 108-112 such as personal computers, laptop computers, tablet computers, portable media players, digital media receivers, and/or other network-enabled electronic devices by acting as a “personal hotspot” for client devices 108-112. For example, a network-sharing apparatus on electronic device 102 may use WiFi, Bluetooth (Bluetooth™ is a registered trademark of Bluetooth SIG, Inc.), Universal Serial Bus (USB), and/or another communications mechanism to provide internal interfaces 118-122 with which client devices 108-112 may connect to access cellular network 104. Client devices 108-112 may then use internal interfaces 118-122 to send and receive emails, retrieve webpages, stream audio and/or video, transfer files, share desktops, and/or perform other Internet-enabled tasks over external interface 116.

Those skilled in the art will appreciate that the transition of Internet infrastructure from Internet Protocol version 4 (IPv4) to Internet Protocol version 6 (IPv6) may require the deployment of IPv6 on most Internet hosts, routers, and/or other network nodes on the Internet. As a result, IPv6 connectivity may not be available to client devices 108-112 through internal interfaces 118-122 unless electronic device 102, network link 106, and network 104 all support IPv6.

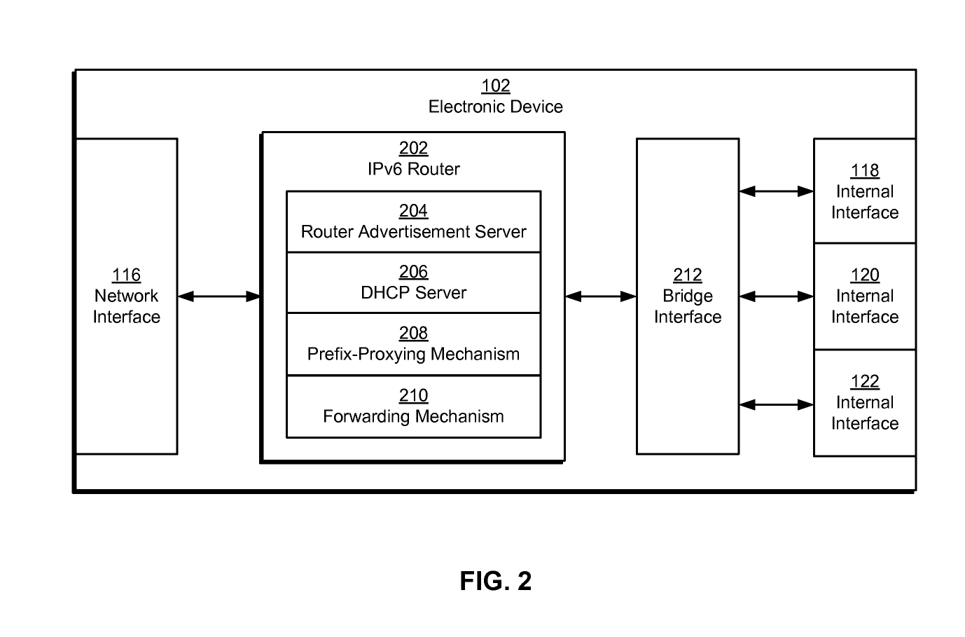

In one or more embodiments, electronic device 102 includes functionality to provide IPv6 connectivity through internal interfaces 118-122 if network 104 and network link 106 are also IPv6-capable. As discussed below with respect to FIGS. 2-4, such IPv6 connectivity may be provided through an IPv6 router in electronic device 102, as well as mechanisms in the IPv6 router and/or electronic device 102 for performing prefix proxying with client devices 108-112 and/or providing IPv6 Domain Name System (DNS) information to client devices 108-112. In turn, the IPv6 router may allow client devices 108-112 that are not directly connected to network 104 to appear as if client devices 108-112 are on network 104, thus allowing client devices 108-112 to access the Internet and/or communicate with other network nodes through network 104.

FIG. 2 shows a system for sharing an Internet connection in accordance with the disclosed embodiments. As shown in FIG. 2, electronic device 102 may provide an IPv6 router 202 to client devices (e.g., client devices 108-112 of FIG. 1) connected to internal interfaces 118-122. IPv6 router 202 may be provided by a control apparatus (e.g., operating system kernel, daemon, etc.) in electronic device 102. IPv6 router 202 includes a router advertisement server 204, a Dynamic Host Configuration Protocol (DHCP) server 206, a prefix-proxying mechanism 208, and a forwarding mechanism 210. As described below, the components of IPv6 router may enable various aspects of IPv6 communication between the client devices and/or external interface 116, including neighbor discovery, domain name resolution, IPv6 packet routing, and/or prefix proxying.

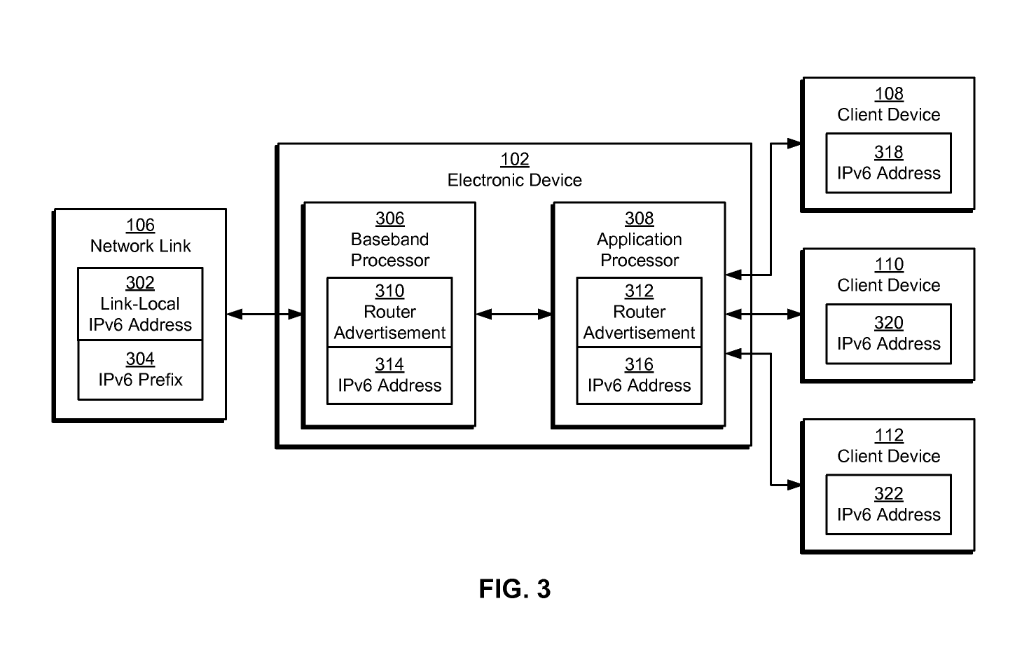

Router advertisement server 204 may provide router advertisements (e.g., Internet Control Message Protocol version 6 (ICMPv6) router advertisements) that notify the client devices of the presence of IPv6 router 202. For example, router advertisement server 204 may periodically multicast a router advertisement from each internal interface 118-122 to announce the IPv6 address of the internal interface. The router advertisement may include an IPv6 prefix from external interface 116 and/or prefix information for the IPv6 prefix that may be used by the client devices to generate unique IPv6 addresses from the IPv6 prefix. The router advertisement may also include IPv6 DNS information that enables the resolution of domain names into IPv6 addresses by the client devices. Transmission of router advertisements from electronic device 102 to the client devices is discussed in further detail below with respect to FIG. 3.

DHCP server 206 may also provide IPv6 DNS information to the client devices. For example, DHCP server 206 may be a stateless DHCP server that obtains IPv6 DNS information (e.g., DNS name server addresses) from external interface 116, maintains the IPv6 DNS information in a dynamic store, and provides the IPv6 DNS information to the client devices upon request from the client devices. To further enhance compatibility with different types of client devices, both router advertisement server 204 and DHCP server 206 may provide the IPv6 DNS information to the client devices. For example, router advertisement server 204 may use a DNS extension to embed the IPv6 DNS information in a router advertisement to each client device, while DHCP server 206 may include the IPv6 DNS information in a reply to an information-request message from a client device.

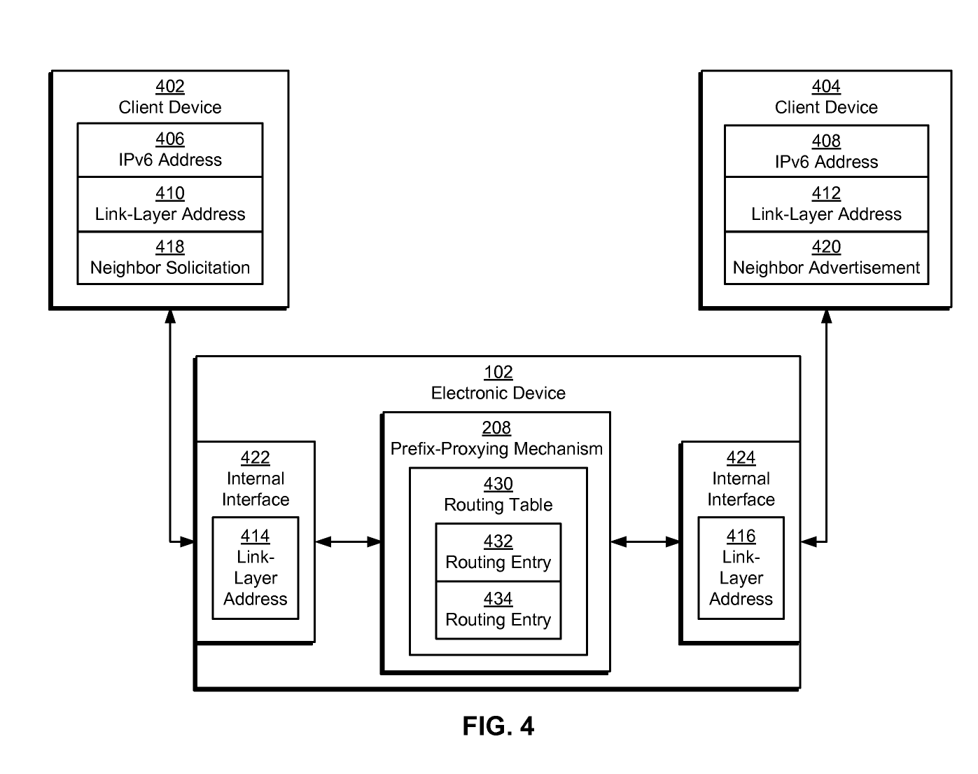

Prefix-proxying mechanism 208 may enable neighbor discovery operations (e.g., using the Neighbor Discovery Protocol (NDP) and/or ICMPv6) between the client devices by routing and/or modifying ICMPv6 informational messages between the client devices. Prefix-proxying mechanism 208 may additionally build a routing table containing routes to the client devices using information from the neighbor discovery packets. The routing table may further include an unscoped routing entry for external interface 116 and a set of scoped routing entries for internal interfaces 118-122. Consequently, prefix-proxying mechanism 208 may allow independent internal interfaces 118-122 on multiple links to use the same IPv6 prefix and be seen as inside the same broadcast domain, as discussed in further detail below with respect to FIG. 4.

Finally, forwarding mechanism 210 may route packets between external interface 116 and the client devices. For example, forwarding mechanism 210 may use the routing table created by prefix-proxying mechanism 208 to track IPv6 addresses generated by the client devices using the IPv6 prefix provided to the client devices by router advertisement server 204. After a packet is received at an interface (e.g., external interface 116, internal interfaces 118-122), forwarding mechanism 210 may map the destination address of the packet to an IPv6 address in the routing table and forward the packet to the interface associated with the IPv6 address.

As shown in FIG. 2, forwarding mechanism 210, IPv6 router 202, and/or another component of electronic device 102 may provide a bridge interface 212 that allows internal interfaces 118-122 to appear as a single interface to the operating system of electronic device 102. For example, bridge interface 212 may be a virtual interface provided by a software component that resides between the network stack and physical interfaces (e.g., external interface 116, internal interfaces 118) of electronic device 102. IPv6 router 202 may transmit router advertisements containing the IPv6 prefix obtained from external interface 116 and the IPv6 address of IPv6 router 202 to the client devices via bridge interface 212 to establish IPv6 router 202 as the IPv6 router between the client devices and the network (e.g., network 104 of FIG. 1). Packets from external interface 116 and/or internal interfaces 118-122 may then be received by bridge interface 212 and forwarded to the interfaces associated with the packets' destinations.

In one or more embodiments, the components of IPv6 router 202 are initiated based on input from a user of electronic device 102 and/or use of internal interfaces 118-122 by the client devices. For example, the user may select a setting within a graphical user interface (GUI) of electronic device 102 to enable Internet sharing on electronic device 102. After Internet sharing is enabled, electronic device 102 may initialize internal interfaces 118-122. For example, one or more management components (e.g., operating system, driver, etc.) in the network-sharing apparatus on electronic device 102 may configure a radio on electronic device 102 to operate as a “lightweight” wireless access point and/or master Bluetooth device. The management components may also allow the client devices to connect to electronic device 102 through a wired USB interface on electronic device 102 by, for example, enabling use of the USB interface on electronic device 102.

The management components may detect and/or enable the connection of client devices to internal interfaces 118-122. For example, a management component for a USB interface may receive an interrupt indicating the plugging in of a client device to the USB interface after an increase in the voltage across the USB interface is detected. Similarly, a management component for a WiFi and/or Bluetooth interface may detect requests by client devices to wirelessly connect to the WiFi and/or Bluetooth interface and communicate with the client devices to establish the wireless connections.

Once connections between the client devices and internal interfaces 118-122 are detected, the control apparatus may configure electronic device 102 to provide IPv6 connectivity to the client devices. The control apparatus may include a daemon on electronic device 102 that executes to verify that all requirements associated with Internet sharing on electronic device 102 are met. For example, the daemon may authenticate the user of electronic device 102 and/or determine if the user has paid for and/or otherwise enabled Internet sharing on electronic device 102. If Internet sharing is to be allowed, the daemon may determine if external interface 116 supports IPv6, as discussed in further detail below with respect to FIG. 3. If the external interface does not support IPv6, the daemon may proceed with configuring electronic device 102 to provide IPv4 connectivity to the client devices.

If external interface 116 supports IPv6, the daemon may initialize one or more other daemons that provide router advertisement server 204 and DHCP server 206. The daemon may also configure the operating system of electronic device 102 to provide forwarding mechanism 210, prefix-proxying mechanism 208, and/or bridge interface 212. Router advertisement server 204 and/or DHCP server 206 may then provide router advertisements and/or DNS information to the client devices, and prefix-proxying mechanism 208 may route ICMPv6 informational messages and/or build a routing table during neighbor discovery between the client devices. Finally, forwarding mechanism 210 may use the routing table to route packets between external interface 116 and the client devices.

The daemon may also respond to events related to the link status of external interface 116. For example, if the connection to external interface 116 is lost (e.g., due to changes in cellular coverage), the daemon may invalidate the IPv6 prefix obtained from external interface 116 to stop the client devices from using the IPv6 prefix. Once the connection to external interface 116 is reestablished, the daemon may reconfigure electronic device 102 to provide IPv6 router 202 by verifying use of Internet sharing on electronic device 102, determining support of IPv6 by external interface 116, initializing other daemons, and/or configuring the operating system of electronic device 102 to provide various components of IPv6 router 202. Along the same lines, the daemon may respond to the expiration of the IPv6 prefix by obtaining a new IPv6 prefix from external interface 116 and updating router advertisement server 204 and/or DHCP server 206 with the new IPv6 prefix and/or other information from external interface 116. The new IPv6 prefix may then be used by the client devices and/or IPv6 router 202 to perform neighbor discovery, build the routing table, and communicate with one another and/or other network nodes on the Internet.

FIG. 3 shows the configuring of electronic device 102 to provide an IPv6 router (e.g., IPv6 router 202 of FIG. 2) to a set of client devices 108-112 in accordance with the disclosed embodiments. As mentioned above, electronic device 102 may be a mobile phone and/or other device that is capable of communicating with a cell tower providing network link 106 in a cellular network. As shown in FIG. 3, communication between electronic device 102 and network link 106 may be managed by a baseband processor 306 in electronic device 102, while communication between electronic device 102 and client devices 108-112 may be managed by an application processor 308 in electronic device 102.

More specifically, baseband processor 306 may receive IPv4 and/or IPv6 configuration information from network link 106. If network link 106 supports IPv6, baseband processor 306 may obtain a link-local IPv6 address 302 and an IPv6 prefix 304 from network link 106. Baseband processor 306 may then use IPv6 prefix 304 to generate an IPv6 address 314 for baseband processor 306, thus allowing baseband processor 306 to act as an IPv6 router for application processor 308 using a virtual interface with application processor 308.

Next, baseband processor 306 may transmit a router advertisement 310 (e.g., an Internet Control Message Protocol (ICMP) router advertisement) containing IPv6 prefix 304 to application processor 308, and application processor 308 may use IPv6 prefix 304 to generate a different IPv6 address 316 for application processor 308. As a result, application processor 308 may also be configured as an IPv6 router (e.g., IPv6 router 202 of FIG. 2) for client devices 108-112.

As an IPv6 router, application processor 308 may periodically multicast a different router advertisement 312 containing IPv6 prefix 304 over internal interfaces (e.g., internal interfaces 118-122 of FIG. 1) to which client devices 108-112 are connected. Router advertisement 312 may also include IPv6 address 316 to establish application processor 308 as the IPv6 router. Moreover, router advertisement 312 may omit the IPv6 address of network link 106 because the IPv6 router on network link 106 is not reachable by client devices 108-112. Router advertisement 312 and IPv6 prefix 304 may then be received by client devices 108-112 and used by each client device 108-112 to generate a unique IPv6 address 318-322 for the client device, as discussed in further detail below with respect to FIG. 4. Because IPv6 prefix 304 is shared by baseband processor 306, application processor 308, and client devices 108-112, client devices 108-112 may appear to be on the same link as baseband processor 306 and application processor 308, even though the internal interfaces to which client devices 108-112 are connected are on different physical links.

In one or more embodiments, configuration of baseband processor 306 and application processor 308 as IPv6 routers and/or generation of IPv6 addresses 314-322 using IPv6 prefix 304 are based on link-local IPv6 address 302, IPv6 prefix 304, and/or other prefix information for IPv6 prefix 304. The prefix information may be obtained from network link 106 and include IPv6 prefix 304, one or more flags, and/or a prefix lifetime. As with IPv6 prefix 304, the prefix information may be passed from network link 106 to client devices 108-112 using router advertisements 310-312.

For example, baseband processor 306 and/or application processor 308 may determine that network link 106 supports IPv6 by obtaining link-local IPv6 address 302 from network link 106. Baseband processor 306 and/or application processor 308 may then wait for a pre-specified period (e.g., a few seconds) to obtain IPv6 prefix 304 from network link 106. If link-local IPv6 address 302 and/or IPv6 prefix 304 are missing from network link 106, baseband processor 306 and/or application processor 308 may omit routing of IPv6 packets between client devices 108-112 and network link 106.

If both link-local IPv6 address 302 and IPv6 prefix 304 are available, baseband processor 306 and/or application processor 308 may determine that IPv6 addresses 314-322 can be configured from IPv6 prefix 304 if IPv6 prefix 304 is 64-bits long (e.g., which allows for the creation of anycast and/or unicast addresses using IPv6 prefix 304). Baseband processor 306 and/or application processor 308 may further determine that IPv6 prefix 304 can be used to configure IPv6 addresses 314-322 if an “autoconfigure” flag in the prefix information is set and/or if the prefix lifetime for IPv6 prefix 304 is not expired.

Baseband processor 306 and/or application processor 308 may then provide IPv6 prefix 304, prefix information for IPv6 prefix 304, and/or IPv6 DNS information to client devices 108-112 (e.g., using router advertisements 310-312 and/or a DHCP server (e.g., DHCP server 206 of FIG. 2)). Router advertisements 310-312 may thus enable use of IPv6 prefix 304 by client devices 108-112 before the prefix lifetime of IPv6 prefix 304 expires. Baseband processor 306 and/or application processor 308 may additionally configure electronic device 102 to perform prefix proxying with client devices 108-112, as discussed below with respect to FIG. 4. Finally, baseband processor 306 and/or application processor 308 may invalidate IPv6 prefix 304 after the prefix lifetime expires.

Once IPv6 connectivity is enabled for client devices 108-112, IPv6 packets destined for client devices 108-112 may be received from network link 106 by baseband processor 306. Baseband processor 306 may detect the presence of IPv6 prefix 304 in the destination addresses of the IPv6 packets and forward to the IPv6 packets to application processor 308. A forwarding mechanism (e.g., forwarding mechanism 210 of FIG. 2) executing on application processor 308 may use a routing table residing in memory on electronic device 102 to forward the IPv6 packets to client devices 108-112. Alternatively, if an IPv6 packet cannot be forwarded to a client device using the routing table, the forwarding mechanism may perform address resolution to attempt to resolve the physical address of the IPv6 packet's destination.

If the “autoconfigure” flag is not set, or if IPv6 prefix 304 is unavailable and/or not 64-bits long, baseband processor 306 and/or application processor 308 may determine that IPv6 addresses 314-322 cannot be configured using IPv6 prefix and omit routing of IPv6 packets between client devices 108-112 and network link 106. Instead, baseband processor 306 and/or application processor 308 may route only IPv4 packets between client devices 108-112 and network link 106.

FIG. 4 shows the performing of prefix proxying by electronic device 102 with a set of client devices 402-404 in accordance with the disclosed embodiments. Each client device 402-404 may be connected to an internal interface 422-424 provided by a network-sharing apparatus on electronic device 102. For example, client devices 402-404 may be connected to internal interfaces 422-424 using WiFi, Bluetooth, USB, and/or another communications mechanism. Prefix-proxying mechanism 208 may be provided by an operating system kernel and/or other component of electronic device 102. As described below, prefix-proxying mechanism 208 may enable the generation of an IPv6 address 406-408 for each client device 402-404 using the same IPv6 prefix (e.g., IPv6 prefix 304 of FIG. 3) from an external interface (e.g., external interface 116 of FIG. 1) providing Internet access to electronic device 102.

As mentioned above, client devices 402-404 may obtain the IPv6 prefix from a router advertisement provided by a router advertisement server (e.g., router advertisement server 204 of FIG. 2) in electronic device 102 and generate IPv6 addresses 406-408 from the IPv6 prefix. For example, client devices 402-404 may randomly generate the lower 64 bits of IPv6 addresses 406-408 and/or obtain the lower 64 bits from link-layer addresses 410-412 (e.g., Media Access Control (MAC) addresses) associated with client devices 402-404.

To verify the uniqueness of IPv6 addresses 406-408 and/or locate other client devices connected to electronic device 102, each client device 402-404 may use NDP and/or ICMPv6 to perform neighbor discovery operations such as duplicate address detection, address resolution, and/or neighbor unreachability detection. During such neighbor discovery operations, prefix-proxying mechanism 208 may modify and/or route ICMPv6 packets between client devices 402-404 to enable sharing of the same IPv6 prefix across multiple links (e.g., internal interfaces 422-424). Prefix-proxying mechanism 208 may additionally construct a routing table 430 (e.g., an NDP Neighbor Cache) using information from the ICMPv6 packets for subsequent use by a forwarding mechanism (e.g., forwarding mechanism 210 of FIG. 2) in routing packets between client devices 402-404, other client devices connected to electronic device 102, and/or the external interface.

In particular, client devices 402-404 may use neighbor solicitation 418 and/or neighbor advertisement 420 packets to perform neighbor discovery operations. For example, client device 404 may already be connected to internal interface 424 and have an IPv6 address 408 and link-layer address 412 for use in communicating with other network nodes. IPv6 address 408 and link-layer address 412 may be stored in a routing entry 432-434 for client device 404 in routing table 430.

Next, client device 402 may connect to internal interface 422, receive a router advertisement containing the IPv6 prefix from electronic device 102, and generate IPv6 address 406 using the IPv6 prefix. Client device 402 may then perform duplicate address detection using NDP and/or ICMPv6 by transmitting a neighbor solicitation 418 (e.g., a DupAddrDetectTransmits neighbor solicitation) to internal interface 422, the only neighbor on the same link as client device 402. Neighbor solicitation 418 may include a Target Address of IPv6 address 406 and a Source Link-Layer Address (SLLA) set to link-layer address 410.

Prefix-proxying mechanism 208 may obtain neighbor solicitation 418 from internal interface 422 and remember client device 402 as the source of neighbor solicitation 418 by updating routing table 430 with a routing entry 432-434 (e.g., neighbor cache entry) containing IPv6 address 406 and link-layer address 410. Next, prefix-proxying mechanism 208 may modify the SLLA of neighbor solicitation 418 to a link-layer address 416 of internal interface 424 and transmit the modified neighbor solicitation 418 to client device 404 over internal interface 424. Prefix-proxying mechanism 208 may also retransmit neighbor solicitation 418 over other internal interfaces (not shown) in electronic device 102 to which client devices other than client devices 402-404 are connected, with the SLLA of each transmitted neighbor solicitation 418 changed to the link-layer address of the corresponding internal interface.

Client device 404 may receive neighbor solicitation 418 over internal interface 424 and examine neighbor solicitation 418 to determine if IPv6 address 406 collides with IPv6 address 408. If IPv6 address 406 does not collide with IPv6 address 408, client device 404 may discard neighbor solicitation 418. Client device 402 may then determine that IPv6 address 406 is unique after a pre-specified period has passed after the transmission of neighbor solicitation 418 and use IPv6 address 406 to communicate with client device 404 and/or other network nodes on the Internet.

On the other hand, if IPv6 address 406 collides with (e.g., is a duplicate of) IPv6 address 408, client device 404 may transmit a neighbor advertisement 420 to internal interface 424. Neighbor advertisement 420 may include the same Target Address as neighbor solicitation 418 (e.g., IPv6 address 406 or IPv6 address 408), an SLLA set to link-layer address 412, and a Target Link-Layer Address (TLLA) set to link-layer address 416.

Prefix-proxying mechanism 408 may receive neighbor advertisement 420 from internal interface 424 and use the Target Address and/or TLLA of neighbor advertisement 420 and routing table 430 to identify client device 402 as the destination of neighbor advertisement 420. Finally, prefix-proxying mechanism 208 may replace the TLLA of neighbor advertisement 420 with link-layer address 414 of internal interface 422 and forward neighbor advertisement 420 over internal interface 422 to client device 402, thus informing client device 402 of the duplicate state of IPv6 address 406. Client device 402 may then generate a new IPv6 address 406 and transmit IPv6 address 406 in neighbor solicitation 418 until IPv6 address 406 is determined to be unique (e.g., no neighbor advertisement is received in response to neighbor solicitation 418). By routing and/or modifying neighbor solicitation 418 and/or neighbor advertisement 420 between client devices 402-404, prefix-proxying mechanism 408 may allow client devices 402-404 to perform duplicate address detection, even if client devices 402-404 are on different links.

Once client device 402 has established a unique IPv6 address 406 using duplicate address detection, client device 402 may perform address resolution to identify the link-layer addresses (e.g., link-layer address 412) of other client devices (e.g., client device 404) connected to electronic device 102. Client device 402 may also use neighbor unreachability detection to detect if another client device with which client device 402 was communicating is still reachable.

As with duplicate address detection, client device 402 may perform address resolution and/or neighbor unreachability detection by transmitting a neighbor solicitation (e.g., neighbor solicitation 418) to internal interface 422. Next, prefix-proxying mechanism 208 may forward the neighbor solicitation with a modified SLLA over internal interface 424 and/or another internal interface of electronic device 102 to which a client device for which the neighbor solicitation is destined is connected. The client device may respond to the neighbor solicitation with a neighbor advertisement, and prefix-proxying mechanism 208 may receive the neighbor advertisement over the internal interface to which the client device is connected. Finally, prefix-proxying mechanism 208 may forward the neighbor advertisement with a modified TLLA over internal interface 422 to enable use of information in the neighbor advertisement by client device 402.

Prefix-proxying mechanism 208 may similarly perform duplicate address detection, address resolution, neighbor unreachability detection, and/or other neighbor discovery operations for other client devices (e.g., client device 404) connected to electronic device 102. For example, prefix-proxying mechanism 208 may receive neighbor solicitations from client device 404 and forward the neighbor solicitations with modified SLLAs to client device 402 and/or other client devices for which the neighbor solicitations are destined. Prefix-proxying mechanism 208 may then receive neighbor advertisements in response to the neighbor solicitations from the other client device(s) and forward the neighbor advertisements with modified TLLAs to client device 404.

To further facilitate neighbor discovery and/or packet routing between the external interface and internal interfaces 422-424, prefix-proxying mechanism 208 and/or another component of electronic device 102 may install an unscoped (e.g., global) routing entry (e.g., routing entries 432-434) for the external interface and scoped routing entries for internal interfaces 422-424 in routing table 430. To install the unscoped and scoped routing entries, the router advertisement server may be configured to transmit router advertisements containing the IPv6 prefix over a bridge interface (e.g., bridge interface 212 of FIG. 2). Next, a control apparatus (e.g., operating system kernel) may configure the bridge interface to operate in a special “router only” mode, which prevents IPv6 router advertisements from being processed on the bridge interface. Such configuration of the bridge interface may enable “loop avoidance” in case one or more client devices 402-404 are also configured to act as IPv6 routers. Conversely, the “router only” mode may allow the bridge interface to accept locally generated IPv6 router advertisements from the router advertisement server.

When the bridge interface obtains a router advertisement from the router advertisement server, the bridge interface may install the IPv6 prefix from the router advertisement into electronic device 102 and generate a global IPv6 address from the IPv6 prefix. Moreover, the control apparatus may detect that the same IPv6 prefix is associated with the external interface, which is associated with an unscoped routing entry in routing table 430, and cause the IPv6 prefix for the bridge interface and/or internal interfaces 422-424 to be installed as one or more scoped routing entries in routing table 430.

The scoped routing entries may thus be limited to the respective internal interfaces 422-424, while the unscoped routing entry may represent a default router for interface links between the external interface and internal interfaces 422-424. In addition, the routing entries may share the same IPv6 prefix, as described above. Finally, all-multicast mode may be enabled for the external interface and internal interfaces 422-424 to allow solicited-node packets for neighbor discovery (e.g., address resolution, neighbor unreachability detection) to be handled.

Such scoping of routing entries (e.g., routing entries 432-434) in routing table 430 may allow all interfaces sharing the same IPv6 prefix (e.g., the external interface, internal interfaces 422-424, etc.) to be quickly identified, thus enabling the copying of an ICMPv6 informational packet (e.g., a neighbor solicitation) from one interface to the other interfaces. The scoping may also allow changes to the IPv6 prefix and/or additional IPv6 prefixes from the external interface to be shared and/or propagated quickly among the interfaces. Scoping of routing entries is discussed in a co-pending non-provisional application by inventor Cahya A. Masputra, entitled “System and Method for Managing Routers and Communication Interfaces on a Computing Device,” having serial number TO BE ASSIGNED, and filing date TO BE ASSIGNED (Attorney Docket No. 4860.P10428), which is incorporated herein by reference.

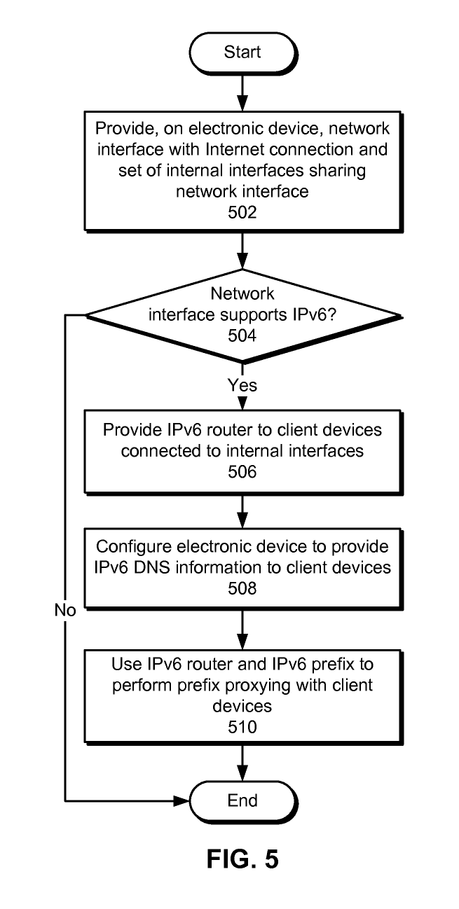

FIG. 5 shows a flowchart illustrating the process of sharing an Internet connection in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the technique.

Initially, a external interface with the Internet connection and a set of internal interfaces sharing the external interface are provided on an electronic device (operation 502). For example, the electronic device may be a mobile phone that connects to the Internet through a cell tower and provides a WiFi, USB, and/or Bluetooth interface to which a set of client devices may connect to share the Internet connection.

The electronic device may be configured based on the support of IPv6 by the external interface (operation 504). For example, the external interface may support IPv6 if a link-local IPv6 address and the IPv6 prefix are detected for the external interface. Support for IPv6 by the external interface may further be determined by detecting a configurability of IPv6 addresses by the client devices using IPv6 prefix information for the IPv6 prefix. For example, the external interface may support use of IPv6 by the client devices if the IPv6 prefix is a specific length (e.g., 64 bits), the prefix lifetime for the IPv6 prefix is not expired, and/or an “autoconfigure” flag for the IPv6 prefix is set.

If the external interface does not support IPv6 (e.g., if the link-local IPv6 address or the IPv6 prefix are missing and/or the prefix information indicates a lack of configurability of IPv6 addresses by the client devices), IPv6 connectivity may be omitted from the shared Internet connection. Instead, IPv4 connectivity may be provided to the client devices through the shared Internet connection.

If the external interface supports IPv6, the electronic device may be configured to provide IPv6 connectivity to the client devices connected to the internal interfaces by providing an IPv6 router to the client devices (operation 506). The IPv6 router may use a router advertisement to provide the IPv6 prefix information to the client devices. For example, the IPv6 router may periodically transmit the router advertisement to the client devices, and the client devices may generate IPv6 addresses using the IPv6 prefix.

The electronic device may also be configured to provide IPv6 DNS information to the client devices (operation 508). The IPv6 DNS information may be provided in router advertisements from the IPv6 router and/or by a stateless DHCP server executing on the electronic device.

Finally, the IPv6 router and IPv6 prefix are used to perform prefix proxying with the client devices (operation 510). During the prefix proxying, neighbor discovery (e.g., duplicate address detection, address resolution, neighbor unreachability detection, etc.) between the client devices may be performed using the IPv6 prefix, and information from the neighbor discovery may be used to build a routing table for the IPv6 router. The routing table may then be used by the IPv6 router to track IPv6 addresses generated using the IPv6 prefix by the client devices and route packets between the external interface and the client devices.

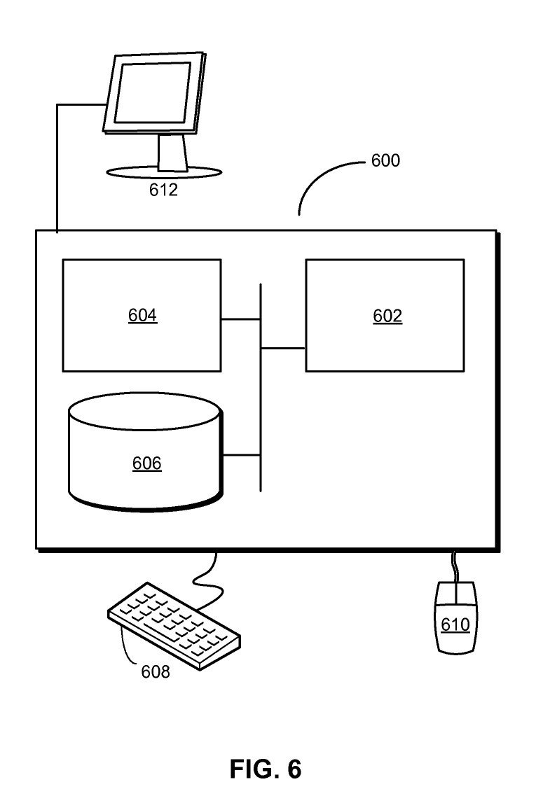

FIG. 6 shows a computer system 600 in accordance with the disclosed embodiments. Computer system 600 may correspond to an apparatus that includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for sharing an Internet connection. The system may include a network-sharing apparatus that provides a external interface with the Internet connection and one or more internal interfaces sharing the external interface. The system may also include a control apparatus. Upon detecting a support of Internet Protocol version 6 (IPv6) by the external interface, the control apparatus may provide IPv6 connectivity to the internal interfaces by providing an IPv6 router to client devices connected to the internal interfaces and using the IPv6 router and an IPv6 prefix from the Internet connection to perform prefix proxying with the client devices. The control apparatus may also provide IPv6 DNS information to the client devices.

In addition, one or more components of computer system 600 may be remotely located and connected to the other components over a network.

Portions of the present embodiments (e.g., IPv6 router, router advertisement server, DHCP server, forwarding mechanism, prefix-proxying mechanism, etc.) may also be located on different nodes of a distributed system that implements the embodiments. For example, the present embodiments may be implemented using a number of electronic devices connected to one another and/or a network link of a cellular network that enable sharing of an Internet connectivity from the cellular network with a set of client devices connected to one or more of the electronic devices.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method for sharing an Internet connection, comprising:
providing, on an electronic device, an external interface with the Internet connection and a set of internal interfaces sharing the external interface; and
upon detecting a support of Internet Protocol version 6 (IPv6) by the external interface, configuring the electronic device to provide IPv6 connectivity to the internal interfaces by:
providing an IPv6 router to client devices connected to the internal interfaces; and
using the IPv6 router and an IPv6 prefix from the Internet connection to perform prefix proxying with the client devices.

2. The method of claim 1, wherein upon detecting the support of IPv6 by the external interface, the method further comprises:
configuring the electronic device to provide IPv6 Domain Name System (DNS) information to the client devices.

3. The method of claim 2, wherein the IPv6 DNS information is provided to the client devices using at least one of:
a stateless Dynamic Host Configuration Protocol (DHCP) server; and
a router advertisement from the electronic device to the client devices.

4. The method of claim 1, wherein detecting the support of IPv6 by the external interface comprises:
detecting a link-local IPv6 address and the IPv6 prefix for the external interface.

5. The method of claim 4, wherein detecting the support of IPv6 by the external interface further comprises:
detecting a configurability of IPv6 addresses by the client devices using IPv6 prefix information for the IPv6 prefix.

6. The method of claim 5, wherein providing the IPv6 router to the client devices comprises:
using a router advertisement to provide the IPv6 prefix information to the client devices;
tracking IPv6 addresses generated using the IPv6 prefix by the client devices; and
using the tracked IPv6 addresses to route packets between the external interface and the client devices.

7. The method of claim 5, wherein the IPv6 prefix information comprises at least one of:
the IPv6 prefix;
one or more flags; and
a prefix lifetime.

8. The method of claim 1, wherein using the IPv6 router and the IPv6 prefix from the Internet connection to perform prefix proxying with the client devices comprises:
transmitting a router advertisement for the IPv6 router to the client devices;
performing neighbor discovery between the client devices using the IPv6 prefix; and
using information from the neighbor discovery to build a routing table for the IPv6 router.

9. The method of claim 8, wherein the routing table comprises:
an unscoped routing entry for the external interface; and
a set of scoped routing entries for the internal interfaces.

10. The method of claim 1, wherein the internal interfaces comprise at least one of:
a Universal Serial Bus (USB) interface;
a Bluetooth interface; and
a WiFi interface.

11. A system for sharing an Internet connection, comprising:
a network-sharing apparatus configured to provide, on an electronic device, an external interface with the Internet connection and one or more internal interfaces sharing the external interface; and
a control apparatus on the electronic device, wherein upon detecting a support of Internet Protocol version 6 (IPv6) by the external interface, the control apparatus is configured to provide IPv6 connectivity to the internal interfaces by:
providing an IPv6 router to client devices connected to the internal interfaces; and
using the IPv6 router and an IPv6 prefix from the Internet connection to perform prefix proxying with the client devices.

12. The system of claim 11, wherein upon detecting the support of IPv6 by the external interface, the control apparatus is further configured to:
provide IPv6 Domain Name System (DNS) information to the client devices.

13. The system of claim 12, wherein the IPv6 DNS information is provided to the client devices using at least one of:
a stateless Dynamic Host Configuration Protocol (DHCP) server; and
a router advertisement from the electronic device to the client devices.

14. The system of claim 11, wherein detecting the support of IPv6 by the external interface comprises:
detecting a link-local IPv6 address and the IPv6 prefix for the external interface.

15. The system of claim 14, wherein detecting the support of IPv6 by the external interface further comprises:
detecting a configurability of IPv6 addresses by the client devices using the IPv6 prefix.

16. The system of claim 15, wherein providing the IPv6 router to the client devices comprises:
using a router advertisement to provide the IPv6 prefix information to the client devices;
tracking IPv6 addresses generated using the IPv6 prefix by the client devices; and
using the tracked IPv6 addresses to route packets between the external interface and the client devices.

17. The system of claim 11, wherein using the IPv6 router and the IPv6 prefix from the Internet connection to perform prefix proxying with the client devices comprises:
transmitting a router advertisement for the IPv6 router to the client devices;
performing neighbor discovery between the client devices using the IPv6 prefix; and
using information from the neighbor discovery to build a routing table for the IPv6 router.

18. The system of claim 17, wherein the routing table comprises:
an unscoped routing entry for the external interface; and
a set of scoped routing entries for the internal interfaces.

19. A computer-readable storage medium storing instructions that when executed by a computer cause the computer to perform a method for sharing an Internet connection, the method comprising:
providing, on an electronic device, an external interface with the Internet connection and a set of internal interfaces sharing the external interface; and
upon detecting a support of Internet Protocol version 6 (IPv6) by the external interface, configuring the electronic device to provide IPv6 connectivity to the internal interfaces by:
providing an IPv6 router to client devices connected to the internal interfaces; and
using the IPv6 router and an IPv6 prefix from the Internet connection to perform prefix proxying with the client devices.

20. The computer-readable storage medium of claim 19, wherein upon detecting the support of IPv6 by the external interface, the method further comprises:
configuring the electronic device to provide IPv6 Domain Name System (DNS) information to the client devices.

21. The computer-readable storage medium of claim 20, wherein the IPv6 DNS information is provided to the client devices using at least one of:
a stateless Dynamic Host Configuration Protocol (DHCP) server; and
a router advertisement from the electronic device to the client devices.

22. The computer-readable storage medium of claim 19, wherein detecting the support of IPv6 by the external interface comprises:
detecting a link-local IPv6 address and the IPv6 prefix for the external interface.

23. The computer-readable storage medium of claim 23, wherein detecting the support of IPv6 by the external interface further comprises:
detecting a configurability of IPv6 addresses by the client devices using the IPv6 prefix.

24. The computer-readable storage medium of claim 23, wherein providing the IPv6 router to the client devices comprises:
using a router advertisement to provide the IPv6 prefix information to the client devices;
tracking IPv6 addresses generated using the IPv6 prefix by the client devices; and
using the tracked IPv6 addresses to route packets between the external interface and the client devices.

25. The computer-readable storage medium of claim 19, wherein using the IPv6 router and the IPv6 prefix from the Internet connection to perform prefix proxying with the client devices comprises:
transmitting a router advertisement for the IPv6 router to the client devices;
performing neighbor discovery between the client devices using the IPv6 prefix; and
using information from the neighbor discovery to build a routing table for the IPv6 router.

26. An electronic device, comprising:
a network-sharing apparatus configured to provide an external interface with the Internet connection and one or more internal interfaces sharing the external interface; and
a control apparatus, wherein upon detecting a support of Internet Protocol version 6 (IPv6) by the external interface, the control apparatus is configured to provide IPv6 connectivity to the internal interfaces by:
providing an IPv6 router to client devices connected to the internal interfaces; and
use the IPv6 router and an IPv6 prefix from the Internet connection to perform prefix proxying with the client devices.

27. The electronic device of claim 26, wherein upon detecting the support of IPv6 by the external interface, the control apparatus is further configured to:
provide IPv6 Domain Name System (DNS) information to the client devices.

28. The electronic device of claim 26, wherein detecting the support of IPv6 by the external interface comprises:
detecting a link-local IPv6 address and the IPv6 prefix for the external interface.

29. The electronic device of claim 28, wherein detecting the support of IPv6 by the external interface further comprises:
detecting a configurability of IPv6 addresses by the client devices using the IPv6 prefix.

30. The electronic device of claim 29, wherein providing the IPv6 router to the client devices comprises:
using a router advertisement to provide the IPv6 prefix information to the client devices;
tracking IPv6 addresses generated using the IPv6 prefix by the client devices; and
using the tracked IPv6 addresses to route packets between the external interface and the client devices.

31. The electronic device of claim 26, wherein performing prefix proxying with the client devices comprises:
transmitting a router advertisement from the IPv6 router to the client devices;
transmitting a neighbor solicitation from a first client device to other client devices; and
transmitting a neighbor advertisement from a second client device in response to the neighbor solicitation to the first client device.
